(19) United States
(12) Patent Application Publication
(10) Pub. No.: US 2007/0143859 A1
(43) Pub. Date: Jun. 21, 2007

(54) Access right management apparatus, method and storage medium

(76) Inventors: Mariko Ogi, Kawasaki-shi (JP); Akifumi Sekijima, Kawasaki-shi (JP); Sunao Hashimoto, Kawasaki-shi (JP)

Correspondence Address: GAUTHIER & CONNORS, LLP, 225 FRANKLIN STREET, SUITE 2300, BOSTON, MA, 02110, US

(21) Appl. No.: 11/445,102

(22) Filed: Jun. 1, 2006

(30) Foreign Application Priority Data
Dec. 21, 2005 (JP) 2005-368851

(51) Int. Cl. H04L 9/32

(52) U.S. Cl. 726/27

(57) ABSTRACT

There is provided an apparatus for access right management including a transfer destination determining section that determines a candidate for a group whch, after reorganization, corresponds to a group eliminated due to reorganization, an object determining section that determines an object to which an access right is granted to the eliminated group, a presenting section that presents the candidate to a user, a receiving section that receives from the user an instruction indicating whether or not to transfer, to the candidate, the access right of the eliminated group to the object, and an updating section that updates an access right regarding the object according to the instruction received from the user.

### PRIORITY INFORMATION

This application claims priority to Japanese Patent Application No. 2005-368851, filed on Dec. 21, 2005, which is incorporated herein by reference in its entirety.

### BACKGROUND

1. Technical Field

The present invention generally relates to the management of the granting of rights to access an electronic folder or file and, particularly, to the management of an access right granted to a group consisting of multiple users.

2. Related Art

A typical file management system performs management for granting rights to access a file or folder to a user or a group including a plurality of users and for controlling access by the users or groups having access rights. Organizations such as corporations may employ a database for managing data on the members of the organization or users of an in-house information system. A typical database will store information including each member's department, group, or team (referred to herein collectively as “group”). Often, the file management system implements the access right management in cooperation with the user information database. In such a case, if a group is dissolved due to reorganization, the access right granted to the group is invalidated and those who previously used such rights to access a file or the like will become unable to access those same files. Although creation or discontinuance of groups and changes in group names are common occurrences during reorganizations or realignments within organizations, it is also very common that, after the reorganization, many people will belong to groups which function similarly to the ones they were in before the reorganization. It therefore would be useful if the access rights previously assigned to a group eliminated by the reorganization could be reassigned to a corresponding group present after the reorganization.

### SUMMARY

In one aspect of the invention, there is provided an apparatus for access right management including a transfer destination determining section that determines a candidate for a group whch, after reorganization, corresponds to a group eliminated due to reorganization, an object determining section that determines an object to which an access right is granted to the eliminated group, a presenting section that presents the candidate to a user, a receiving section that receives from the user an instruction indicating whether or not to transfer, to the candidate, the access right of the eliminated group to the object, and an updating section that updates an access right regarding the object according to the instruction received from the user.

### BRIEF DESCRIPTION OF THE DRAWINGS

Embodiments of the present invention will be described in detail based on the following figures, wherein:

FIG. 1 is a view showing the configuration of an object management system according to an exemplary embodiment of the present invention;

FIG. 2 is a view showing an example of data content of management information held in the system;

FIG. 3 is a flowchart showing a part of a process for reassigning an access right to a group;

FIG. 4 is a flowchart showing a remaining part of the process for reassigning an access right to a group;

FIG. 5 is a view showing an example of a user interface screen for reassigning an access right to a mismatch group; and

FIG. 6 is a view showing an example hardware structure of a computer system on which the object management system is implemented.

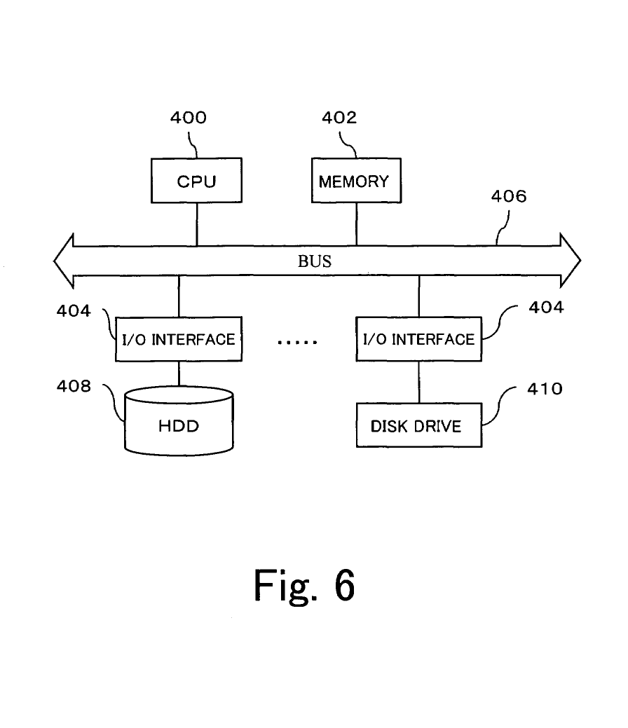

### DETAILED DESCRIPTION

An exemplary embodiment of the present invention is described hereinafter with reference to the drawings.

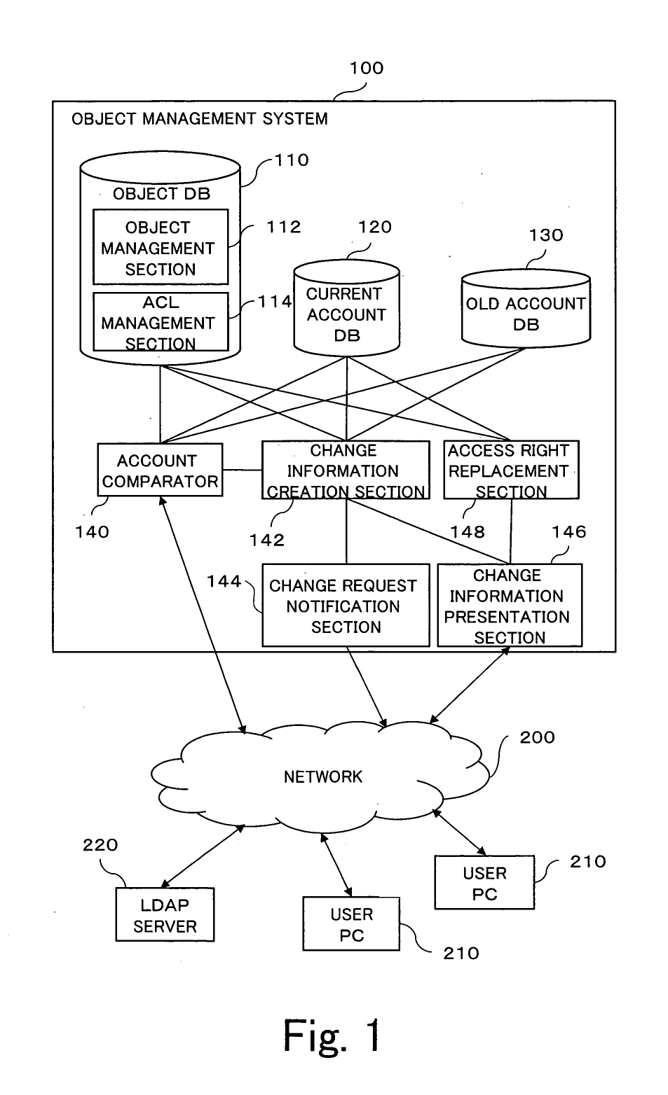

FIG. 1 is a view showing the configuration of an object management system according to the embodiment of the present invention. The object management system 100 stores objects such as files and folders in response to a user request and provides the stored object in response to a user request. An object DB 110 is a database in which objects are registered. The object DB 110 includes an object management section 112 and an ACL management section 114. The object management section 112 manages attribute information of the objects such as files and folders stored in the object DB 110. The attribute information managed by the object management section 112 contains items such as object ID, title, owner information and creation date. The object ID is information identifying an object in a system. Specifically, for example, the object ID is information to identify a type of a folder and a file. The title is a name that is assigned to the object by a creator, and may be, for example, a file name or folder name. The owner information is information identifying an owner of the object, which is typically a creator of the object. The creation date is a date and time when the object was created. The attribute information of objects is not limited to these examples, nor need it necessarily contain all the items exemplified above.

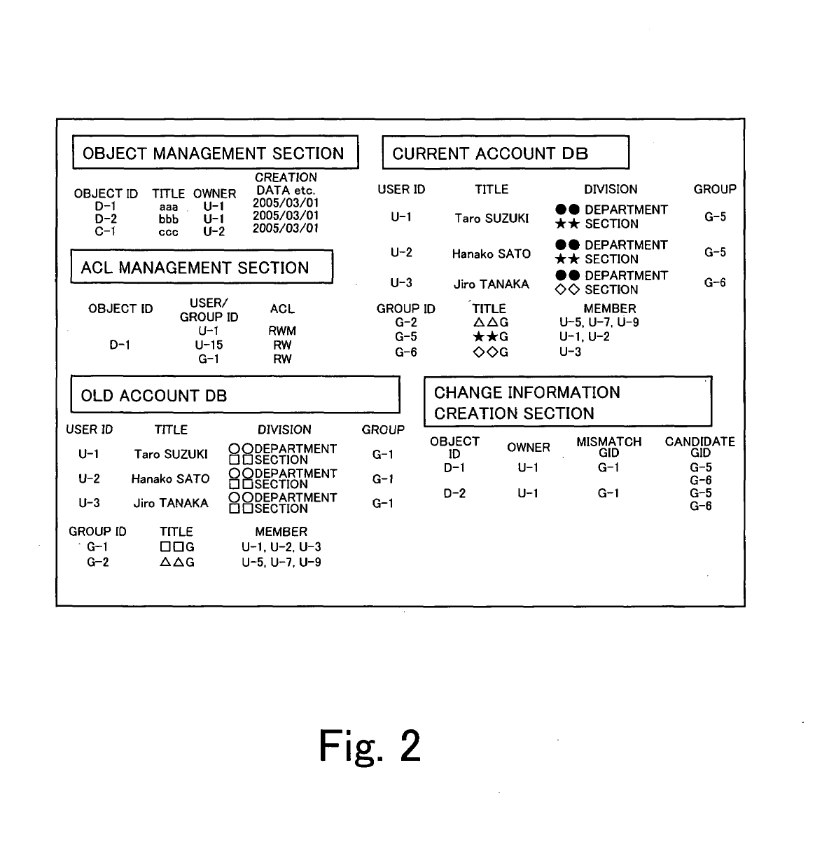

The ACL management section 114 holds an access control list (ACL) which indicates the access right of a user or group to access an object. The ACL management section 114 holds object IDs of objects, and, in association with each object ID, IDs of users or groups authorized to access each object and ACLs indicating the detail of the access rights granted to each user or group. The access rights include aspects such as R (read permission), W (writepermission), and M (managementpermission). Management permission is permission to handle object management information, such as, for example, a right to access an object. In an ACL of a user or group, the aspects of the rights granted to that user or group are listed. In the example shown in FIG. 2, read permission and write permission to the object “D-1” are granted to the group “G-1”. The ACL management section 114 allows only a specific user such as a system administrator who has the management permission for the object management system to modify the ACL.

A current account database DB 120 is used in the management of account information of current users and groups. The user account information typically contains a user ID, title (i.e. user name), division, and group ID as shown in FIG. 2. Although the “division” of a company and the “group” on system management are not necessarily the same, division is an example of a typical actual group. The user account information may further contain other types of information such as user authentication information (e.g. password). The group account information contains a group ID, title (i.e. group name), and a list of group members.

When the object management system 100 receives a request for a file or folder from a user, it identifies the user or discriminates the group to which the user belongs by reference to the current account DB 120.

Upon reorganization, the records which have been stored in the current account DB 120 before the reorganization are transferred to an old account DB 130. Thus, the data structure of the old account DB 130 may be the same as the data structure of the current account DB 120 as shown in FIG. 2. After transferring the data which have been stored in the current account DB 120 to the old account DB 130, a system administrator adds, deletes, or changes the data in the current account DB 120 according to the reorganization. Instead of manually updating the data by the system administrator, it is also possible to obtain the modified organization information from a Lightweight Directory Access Protocol (LDAP) server on a network and store the information into the current account DB 120. In such a case, the system administrator can still manually modify the information in the current account if necessary or desired.

After the outdated account information is transferred to the old account DB 130 upon reorganization and updated account information is built in the current account DB 120, the account comparator 140 ascertains the matching between the two groups. Specifically, the account comparator 140 compares the DB 120 with the DB 130 to determine which groups existing before reorganization no longer exist, i.e. the groups eliminated by the reorganization.

A change information creation section 142 obtains the possible choices (candidates) of a group into which the group eliminated by the reorganization may be converted after the reorganization from the current account DB 120 containing updated account information. How the candidates are obtained is described further below. Specifically, the change information creation section 142 determines a group to which a certain group has been converted as a result of the reorganization. The information creation section 142 then sorts the information on the eliminated group and candidates for a converted group corresponding to the eliminated group by file or folder to which the eliminated group has been authorized access, thereby creating change information. It is possible that information on the owner of the file or folder be retrieved from the object management section 112 and that the retrieved information be added to the change information. The change information created in the change information creation section 142 contains, in association with an object ID of each folder or file, the owner of the file or the like; ID (mismatch group ID (GID) ) of the group which possessed a right to access the file or the like and was eliminated by reorganization and thus mismatches with the existing group after reorganization (such a group is referred to herein as “mismatch group”) and ID (candidate GID) of candidates for the group into which the eliminated group may be converted, as shown in FIG. 2. The change information shown in FIG. 2 corresponds to a case wherein the data stored in the old account DB 130 and the current account DB 120 upon reorganization are as illustrated in FIG. 2. In such a case, the group G-1 is eliminated and the groups G-5 and G-6 are selected as candidates for the group into which the group G-1 has been converted.

A change request notification section 144 creates change request notification which indicates information on the eliminated group and the candidates for a converted group which have been computed by the change information creation section 142, and transmits the created notification to the owner of a document to which the eliminated group has been authorized access.

In response to an access request from a user, a change information presentation section 146 presents to the user the candidates for a group into which the group which was authorized to access the document owned by the user but eliminated by the reorganization is to be converted. The change information presentation section 146 then allows the user to specify to which candidate the access right assigned to the eliminated group should be reassigned, or to specify that the access right should be reassigned to none of the candidates.

An access right replacement section 148 reassigns the access right which was assigned to the eliminated group to the converted group selected by the user according to the candidate selection result sent from the user to the change information presentation section 146.

The configuration of the object management system 100 is as described above. The procedure of the object management system 100 will next be described hereinafter.

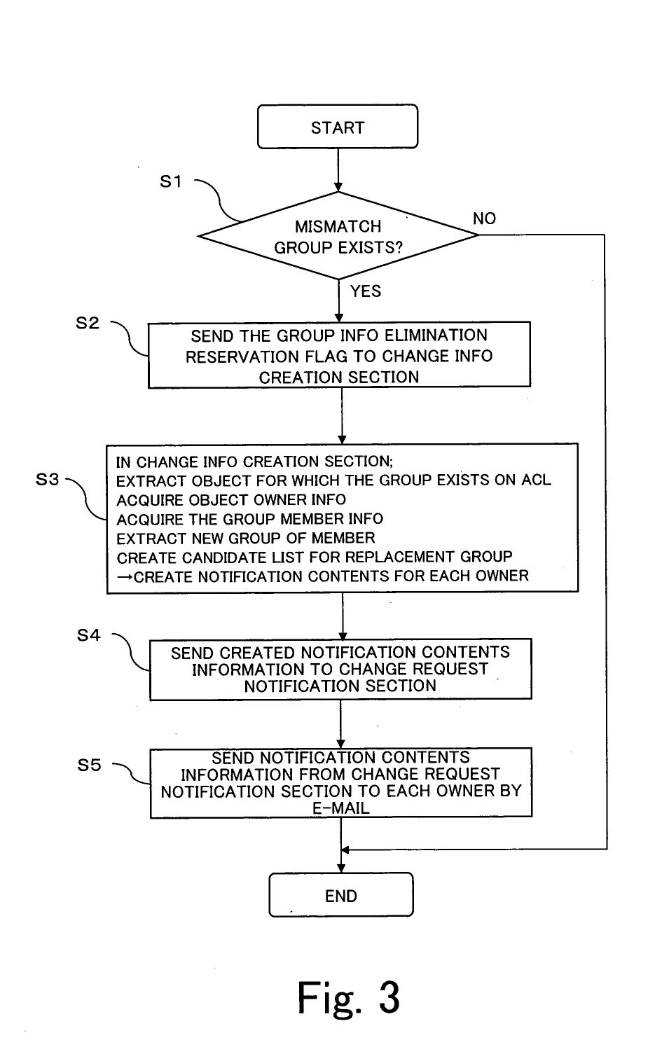

Upon reorganization, the object management system 100 transfers the account information on the users and groups from the current account DB 120 to the old account DB 130. Subsequently, the information on the reorganized users and groups is entered into the current account DB 120 by the manual operation of the system administrator or the information retrieval from a directory server such as an LDAP server. Then, in response to the instruction from the system administrator, the system begins the processing for reassigning the access right to the group. In this processing, the procedure as shown in FIG. 3 is first executed.

In this example, a system administrator or database management system gives a unique ID which does not correspond with any ID of the groups or users either before or after reorganization to a user or group newly created as a result of reorganization. While the ID of the existing group which remains after reorganization is maintained, a unique group ID is newly assigned to a new group which is created due to reorganization.

In the process shown in FIG. 3, the account comparator 140 compares the current account DB 120 with the old account DB 130 to search for a mismatch group (S1). The mismatch group may be found by searching for the group ID which is present in the old account DB 130 but not in the current account DB 120, for example. The account comparator 140 then adds an elimination reservation flag to the mismatch group and sends the information on the group added with the elimination reservation flag to the change information creation section 142 (S2). In the example of FIG. 2, the group ID “G-1” is extracted as the mismatch group and sent to the change information creation section 142.

Receiving the extracted mismatch group, the change information creation section 142 extracts the object where the mismatch group is present on an ACL for each mismatch group and retrieves the information on the owner of the object from the object management section 112. Then, in Step S3, the change information creation section 142 retrieves the information on the members of the group from the old account DB 130 and searches the current account DB 120, thereby obtaining the group to which each member belongs after reorganization. Based on the obtained information, the change information creation section 142 acquires candidates for the group (replacement group) to which the mismatch group might have been converted as a result of the reorganization.

To acquire the candidates for the replacement group to replace the mismatch group, a group in which the proportion of the members of the mismatch group exceeds a predetermined threshold value may be selected from the groups registered in the present account DB 120 (i.e. the groups after reorganization). The group is a collection of individuals, and the access right granted to the group is actually granted to the individuals through the group. Therefore, selecting a group with a high proportion of members previously belonging to the mismatch group before reorganization as a candidate for the replacement group enables efficient granting of an access right to users who previously possessed access rights.

Although in the above example a group comprising a proportion of members previously belonging to the mismatch group exceeding a threshold value is selected as a candidate for the replacement group, a group in which the actual number of members who previously belonged to the mismatch group is higher than a predetermined number of individuals may also be selected as a candidate for the replacement group.

The number of candidates for the replacement group is not necessarily one, and there may be multiple candidates or no candidate at all. If a plurality of candidates exist, the change information creation section 142 creates a list of replacement group candidates. At this time, it is possible to list the replacement group candidates in descending order of the proportion of the members who belonged to the mismatch group and include the information on the ranking sequence in the list. Alternatively, when the criteria of the absolute number of members previously belonging to the mismatch group being greater than a predetermined value is used to determine candidates replacement group, groups having larger absolute numbers of members who belonged to the mismatch group may be ranked higher than groups having fewer such members. Further, it is also possible to calculate an evaluation value through a function which considers both the proportion and the absolute number of members who have so as to select groups whose evaluation value is higher than a predetermined value and create a list which contains the candidates for the replacement group arranged in the descending order of the weighted evaluation value.

Further, in many cases, the owner of an object assigns the right to access the object to the group to which the owner belongs. Thus, if the group of the owner becomes a mismatch group due to reorganization and the access right of the owner to access the object is assigned to the mismatch group, it is possible to select the group to which the owner newly belongs after reorganization as a candidate for the group to replace the mismatch group.

As a result of the above processing, a list of candidates for a replacement group is created for each mismatch group. The information on the object whose ACL contains the mismatch group and the owner of the object is already obtained for each mismatch group. Thus, the change information creation section 142 acquires the mismatch group which has been authorized to access the object owned by each owner and sorts a list of candidates for the replacement group corresponding to each mismatch group. Specifically, the change information creation section 142 gathers the information on the correspondence between the mismatch group related to an owner and the list of candidates for a group to replace the mismatch group for each owner. Then, the change information creation section 142 generates notification contents information which indicates the contents of the notification and which contains the correspondence information for each owner (S3) and sends the notification contents information to the change request notification section 144 (S4).

The change request notification section 144 sends the notification contents information to the relevant owner via email or the like (S5). Such an email message indicates, for example, that there is a group which has been eliminated due to reorganization and that it is possible to reassign the access rights granted to the eliminated group (mismatch group). The email may further contain information on the correspondence between the mismatch group to which the access right to access the object held by the owner who is a destination of the email has been granted and a list of candidate groups to replace the mismatch group. In addition, the email may describe the process for reassigning the access rights which were assigned to the mismatch group to a group created after reorganization. For example, the description may include a URL of a web page displaying a user interface for reassigning the access rights. It is also possible to incorporate the user interface screen for reassigning the access right into a personal page for each user provided by the object management system 100. The URL of the personal page may be protected by a password or the like, for example. In such a case, the email may contain a message prompting the user to access the personal page to activate a reassignment processing.

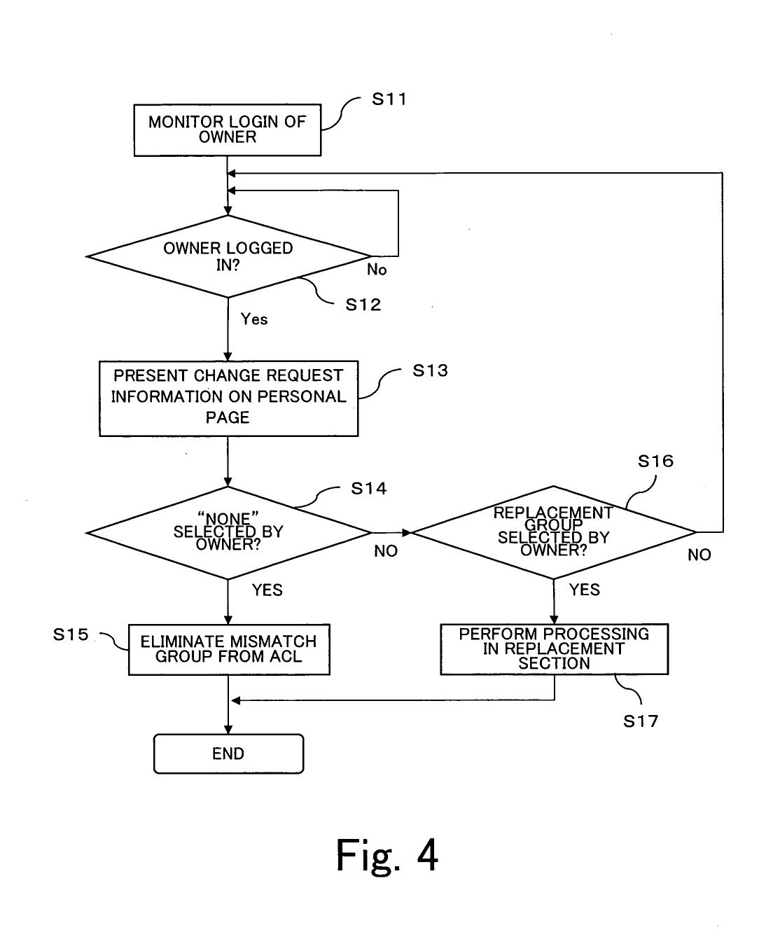

The operation of the system after sending the email for change request will be described hereinafter with reference to FIG. 4, by way of an example in which a personal page is employed.

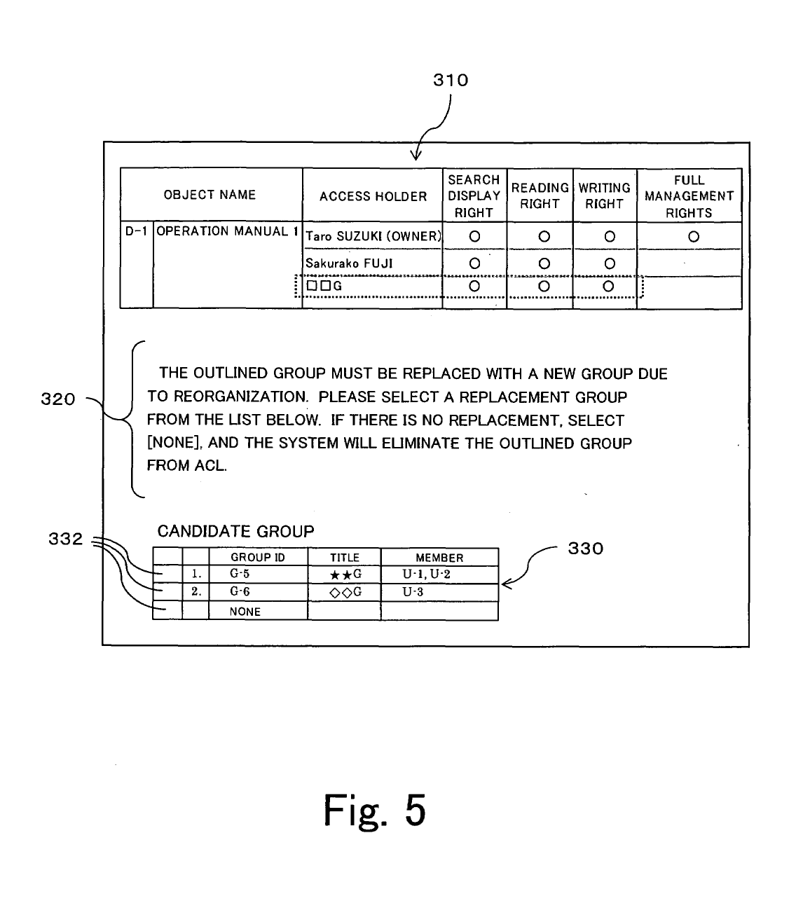

In this processing, the change information presentation section 146 monitors the login of the user to whom the change request has been sent (S11). It is possible to record the destination user in Step S5 for use in the monitoring or, alternatively, to list the owners of the object whose ACL contains the mismatch group in Step S3 and, upon receiving an access from a user on the list, determine that this user is the user to whom the change request was sent. If the monitoring detects the login of the destination user to whom the change request has been sent (S12), the change information presentation section 146 provides the user with a personal page which contains a user interface section for supporting the reassignment of the access right to the group (S13). An example personal page is shown in FIG. 5.

As shown in FIG. 5, the personal page provided to the user displays an object information section 310 which indicates the information on the object whose access right has been granted to the mismatch group and which is owned by the user, a message 320 to explain the process of reassigning the group's access rights, and a list 330 of candidate replacement groups.

The object information section 310 includes information on the ID of a relevant object, object name, access right holder, and presence or absence of each aspect of rights (search & display, read (R), write (W), and full management (M)) authorized to each access right holder. If the user owns a plurality of objects whose access rights have been granted to the mismatch group, the object information section 310 lists the information for each object. The example of FIG. 5 corresponds to the example of data contents shown in FIG. 2 and indicates the information for object D-1 only. In the access right holder column, a group determined to be the mismatch group is distinguishably displayed in a manner different from the other groups. It is also possible to display a list of members of the mismatch group.

The message 320 indicates that a decision regarding reassignment of access rights previously assigned to the group must be made due to reorganization, and describes how to effect a decision (which is, in the example of FIG. 5, the message “Select a replacement group from the candidate groups below, . . . . If there is no replacement, select [none], and the system will eliminate the outlined group from the ACL”). Naturally, this is merely an example message, and the message 320 may include other contents.

The candidate list 330 contains information on the candidates for a replacement group arranged in the descending order of precedence. The information for each group contains a number indicating the precedence order, group ID, title (group name), and list of user IDs of group members. At the end of the list, the option “none” which indicates no replacement is also displayed. Next to the information on each group and the button for selecting “none”, a check box 332 is provided to enable a user to select among the displayed groups.

In the example of FIG. 2, the group G-1 becomes a mismatch group. Because all of the members of both of groups G-5 and G-6 previously belonged to group G-1, that is, both have a proportion of 100%, they are both listed as candidate replacement groups.

In the case shown in FIG. 5, there is only one mismatch group and the user is concerned with only one object whose access rights were granted to the mismatch group. If, on the other hand, a user employs a plurality of objects whose access rights were granted to the mismatch group, the object information section 310 lists the information for each of these objects. In such a case, a list similar to the candidate list 330 shown in FIG. 5 may be displayed for each object. This allows the user to select the replacement group to which the access rights for each object is to be reassigned in a specific and precise manner for each object.

Alternatively, a user may select one replacement group to replace the mismatch group in one step. In such a case, a list of candidates common to all the relevant objects (list 330) is displayed, and the access rights to the objects are transferred to a single replacement group selected by the user from the list. As the user therefore need not separately determine a replacement group for each object, the operating burden on the user is reduced.

Further, if the owner of a file or folder is also the owner of the parent folder, the replacement group selected for the parent folder may be automatically applied to the offspring files or folders as well. Further, instead of applying the group reassignment entirely automatically, it is possible to prompt the user for confirmation as to whether to implement the same replacement for each offspring by way of a dialog screen or the like. In such a case, the candidate list 330 for the offspring file or folder may be displayed to allow a user to input a selection only when the user answers “No” to the dialog. Because the user need only select “Yes” on the dialog to set the same replacement as for the parent, the operating burden is still significantly reduced.

If there are a plurality of mismatch groups which possessed the access rights to one object, the personal page may contain the candidate list 330 for each mismatch group in addition to the object information section 310 for the object. In such a case, the information on the mismatch group in the object information section 310 and the candidate list 330 corresponding to the group may be displayed in a similar manner, such as display using the same color, so that their correspondence can be easily recognized.

If there exist both a plurality of objects and a plurality of mismatch groups which have the right to access each of the objects, the object information section 310 and the candidate list 330 corresponding to each mismatch group may be displayed for each object. This may be done when a user selects the group to replace the same mismatch group for each object. On the other hand, if a user selects the replacement group to replace one mismatch group for all objects, the candidate list may be displayed for each mismatch group.

While viewing their personal page as displayed on their computer screen, a user selects a replacement group (which is G-5 or G-6 in the example of FIG. 5) from the list 330 displayed on their personal computer. The user may select plural replacement groups. If no replacement is desired, the user may mark the column “none”. If the “none” column is marked, the selection made for the candidates is erased.

In this manner, the user selects a candidate from the candidate list, which is transmitted from their personal computer to the object management system 100. In the object management system 100, the change information presentation section 146 receives the transmitted result and determines whether or not “none” was selected (S14) and, if so, the access right replacement section 148 eliminates the mismatch group from the ACL (S15). If the group does not exist in the current account DB 120, it is not necessary to actively eliminate the mismatch group as above because the user is unable to access the object with the access right to this group.

If, on the other hand, the user does not select “none”, the change information presentation section 146 determines whether or not any candidate is selected as a replacement group (S16). If no candidate is selected, it is determined that the input of the user is invalid and the process returns to the initial step. If a replacement group is selected, the access right replacement section 148 replaces the mismatch group included in the ACL of the object owned by the user with the selected replacement group (S17). The content of the access right which is to be granted to the replacement group may be the same as the access rights which were previously granted to the mismatch group. If a plurality of replacement groups are selected, the access rights to each of the selected replacement groups may be added to the ACL.

After the replacement of the group, it is possible to present the screen for setting the access right to each object where the group has been replaced so that the user can adjust the content of each item of the access right to be granted to the replacement group.

Once the user has input a selection on the displayed page, the displayed page is withdrawn.

In the above example, Step S15 (elimination of the mismatch group from ACL) and Step S17 (replacement of the mismatch group with the replacement group on ACL) are executed when the user transmits the selection result of the replacement. Alternatively, the system may predetermine a period for allowing a user to select a replacement group, which is referred to herein as the “grace period”, and first store the user's selection upon receipt. Then, at a given point after the grace period, the system may execute the replacement (S15 and S17) of the ACL for the objects at one time according to the instructions input by the user.

When a grace period is set in the selection of the replacement group, the notification sent to the owner at Step S5 may contain information on the grace period.

Further, if a user does not select a replacement group within the determined grace period, the system may automatically replace the mismatch group. In this case, the system may select the replacement group candidate with the highest evaluation score as the replacement group, eliminate the access rights assigned to the mismatch group from an ACL, and updates the ACL so as to assign the same access rights to the group selected as the replacement group. If the group to which the owner belongs becomes a mismatch group after reorganization and the access rights to the object owned by the owner are assigned to them is match group, the system may automatically select the group to which the owner belongs after reorganization as the replacement group.

In the above processing, the data transferred to the old account DB. 130 may be deleted after the grace period.

In the above example, because the normal account management is performed with the use of the current account DB 120, the user who previously accessed an object using the access right belonging to the mismatch group is unable to access the object until the owner of the object completes the replacement of the access right to the mismatch group. This disadvantage can be eliminated by continuing to provide account management service using f the old account DB 130 during the grace period, and then providing account management services using the current account DB 120 after the grace period. In this case, the selection result of the replacement group sent from each object owner during the grace period may be simultaneously reflected in the ACL after the grace period, rather than immediately upon input.

In the above example, the system maintains two (new and old) sets of account information, such as the current account DB 120 and the old account DB 130, at least during the grace period. Alternatively, the reorganization may be managed using only the current account DB 120, without using the old account DB 130. This may be done, for example, by setting an elimination reservation flag for each record of the groups registered in the current account DB 120 so that a system administrator may set the elimination reservation flag of a group to be eliminated to a value which indicates an elimination target, e.g. “1”. In this case, the flag value “0” may be used to indicate that the group is not to be eliminated. Then, an account of a new group to be created after reorganization is added to the current account DB 120. In such a case, the group ID of the group to which the elimination reservation flag is attached may be reused as the ID of a newly created group. The system then determines a candidate replacement group by the above processing from the groups with the elimination reservation flag of “0”, recognizing that any group with the elimination reservation flag of “1” is a mismatch group. The search range for replacement group candidates may be limited to the newly added groups. After identifying replacement group candidates, the system prompts each owner to select the replacement group and updates the ACL according to the input selections as described above. Then, after the grace period, the record for each group with the elimination reservation flag is deleted from the current account DB 120.

Although in the above example a notice prompting input of the replacement of the mismatch group is sent to a destination user by email, the notification may be communicated by other means. For example, the object management system may display notification on the personal page provided to the user by the system when the user logs onto the system.

An embodiment of the present invention have been described. The object management system described above is typically implemented by executing, in a general-purpose computer, a program in which the function or the processing of each of above-mentioned section is described. Such a computer has a circuit structure in which a CPU (central processing unit) 400, a memory (primary storage) 402, various I/O (input/output) interfaces 404, or the like are connected via a bus 406. Further, a hard disk drive 408 and a disk drive 410 for reading portable, non-volatile storage media of various standards such as CDs, DVDs, or flash memories, are-connected, via the I/O interface 404, for example, to the bus 406. Such a drive 408 or 410 functions as an external storage device with respect to the memory. Specifically, a program in which the processing of the embodiment is described is stored, via a storage medium such as a CD, a DVD, or the like, or via the network, in a fixed storage device such as the hard disk drive 408, and then installed in the computer system. The program stored in the fixed storage device is then read out and stored in the memory and is further executed by the CPU, thereby achieving the processing of the embodiment.

Although the exemplary embodiment of the present invention has been described using specific terms, such description is for illustrative purposes only, and it is to be understood that changes and variations may be made without departing from the spirit or scope of the appended claims.

What is claimed is:

1. An apparatus for access right management, comprising:
a transfer destination determining section that determines a candidate for a group which, after reorganization, corresponds to a group eliminated due to reorganization;
an object determining section that determines an object to which an access right is granted to the eliminated group;
a presenting section that presents the candidate to a user;
a receiving section that receives from the user an instruction indicating whether or not to transfer, to the candidate, the access right of the eliminated group to the object; and
an updating section that updates an access right regarding the object according to the instruction received from the user.

2. The apparatus according to claim 1, wherein
the transfer destination determining section determines the candidate based on a comparison of members of the eliminated group and members of each group present after reorganization.

3. The apparatus according to claim 1, wherein
the transfer destination determining section determines, as a candidate, a group after reorganization in which a proportion of members of the eliminated group with respect to all members of the group is greater than a value.

4. The apparatus according to claim 1, wherein
if the eliminated group is a group to which the owner of the object belongs, a group to which the owner belongs after reorganization is determined to be a candidate.

5. The apparatus according to claim 1, further comprising:
a section that updates the access right regarding the object by transferring the access right granted to the eliminated group to the candidate if the instruction has not been received from the user for a period.

6. A method for access right management, comprising:
determining a candidate for a group which, after reorganization, corresponds to a group eliminated due to reorganization;
determining an object to which an access right is granted to the eliminated group;
presenting the candidate to an user;
receiving from the user an instruction indicating whether or not to transfer, to the candidate, the access right of the eliminated group to the object; and
updating an access right regarding the object according to the instruction.

7. The method according to claim 6, wherein
the candidate is determined based on a comparison of members of the eliminated group and members of each group present after reorganization.

8. The method according to claim 6, wherein
a group after reorganization in which a proportion of members of the eliminated group with respect to all members of the group is greater than a value is determined to be a candidate.

9. The method according to claim 6, wherein,
if the eliminated group is a group to which the owner of the object belongs, a group to which the owner belongs after reorganization is determined to be a candidate.

10. The method according to claim 6, further comprising:
updating the access right regarding the object by transferring the access right granted to the eliminated group to the candidate if the instruction has not been received from the user for a period.

11. A storage medium readable by a computer, the storage medium storing a program of instructions executable by the computer to perform a function for access right management, the function comprising:
determining a candidate for a group which, after reorganization, corresponds to a group eliminated due to reorganization;
determining an object to which an access right is granted to the eliminated group;
presenting the candidate to an user;
receiving from the user an instruction indicating whether or not to transfer, to the candidate, the access right of the eliminated group to the object; and
updating an access right regarding the object according to the instruction.

12. The storage medium according to claim 11, wherein
the candidate is determined based on a comparison of members of the eliminated group and members of each group present after reorganization.

13. The storage medium according to claim 11, wherein
a group after reorganization in which a proportion of members of the eliminated group with respect to all members of the group is greater than a value is determined to be a candidate.

14. The storage medium according to claim 11, wherein
if the eliminated group is a group to which the owner of the object belongs, a group to which the owner belongs after reorganization is determined to be a candidate.

15. The storage medium according to claim 11, the function further comprising:
updating the access right regarding the object by transferring the access right granted to the eliminated group to the candidate if the instruction has not been received from the user for a period.
